(19) United States
(12) Patent Application Publication
(10) Pub. No.: US 2024/0405628 A1
(43) Pub. Date: Dec. 5, 2024

(54) BUS BAR UNIT PRODUCTION METHOD, BUS BAR, BUS BAR UNIT, AND ELECTRIC MACHINE

(71) Applicant: IHI Corporation, Tokyo (JP)

(72) Inventors: Yoshihito KATSU, Tokyo (JP); Shun NAKAYAMA, Tokyo (JP); Yuji SASAKI, Tokyo (JP); Koji SAKOTA, Tokyo (JP)

(21) Appl. No.: 18/804,281

(22) Filed: Aug. 14, 2024

Related U.S. Application Data
(63) Continuation of application No. PCT/JP2022/042742, filed on Nov. 17, 2022.

(30) Foreign Application Priority Data
Feb. 25, 2022 (JP) 2022-028256

(51) Int. Cl. H02K 3/50; H02K 5/22

(52) U.S. Cl. CPC H02K 3/50; H02K 5/22

(57) ABSTRACT

Provided is a bus bar that is used in an electric machine. The bus bar includes a first conductive bar and a first insulation. The first conductive bar includes a first connecting portion and a first insulation portion. The first insulation is provided on a surface of the first insulation portion. The first conductive bar is connected to the second conductive bar through the first insulation and is insulated.

### CROSS-REFERENCE TO RELATED APPLICATION

This application is a continuation application of PCT Application No. PCT/JP2022/042742, filed on Nov. 17, 2022, which claims the benefit of priority from Japanese Patent Application No. 2022-028256 filed on Feb. 25, 2022. The entire contents of the above listed PCT and priority applications are incorporated herein by reference.

### BACKGROUND

The present disclosure relates to a bus bar unit production method, a bus bar, a bus bar unit, and an electric machine.

In the related art, a bus bar unit that is used in an electric machine is known (for example, refer to Japanese Unexamined Patent Publication No. 2014-176213). The bus bar unit includes a plurality of conductive bars, and one insulation that accommodates and holds each of the conductive bars, and electrically insulates each of the conductive bars.

In the bus bar unit described above, since the plurality of conductive bars overlap each other in an axial direction, and the one insulation accommodates approximately the entirety of the conductive bars, the size of the bus bar unit tends to increase.

The present disclosure describes a bus bar unit production method, a bus bar, a bus bar unit, and an electric machine in which a reduction in size may be realized.

### SUMMARY

A bus bar unit production method of the present disclosure is a method for producing a bus bar unit that is used in an electric machine, the method including: a first process of preparing a first conductive bar including a first connecting portion and a first insulation portion, and a second conductive bar including a second connecting portion and a second insulation portion; a second process of providing a first insulation on a surface of the first insulation portion to form a first bus bar, and providing a second insulation on a surface of the second insulation portion to form a second bus bar; and a third process of connecting the second connecting portion to the first insulation portion through the first insulation so that the first insulation portion and the second connecting portion are insulated, thereby forming the bus bar unit including the first bus bar and the second bus bar.

A bus bar of the present disclosure is a bus bar that is used in an electric machine, the bus bar including: a conductive bar including a connecting portion and an insulation portion; and an insulation provided on a surface of the insulation portion, wherein the conductive bar is connected to a conductive bar different from the conductive bar through the insulation, and is insulated.

A bus bar unit of the present disclosure is a bus bar unit that is used in an electric machine, the bus bar including: a first bus bar; and a second bus bar different from the first bus bar, wherein the first bus bar includes a first conductive bar including a first connecting portion and a first insulation portion, and a first insulation provided on a surface of the first insulation portion, the second bus bar includes a second conductive bar including a second connecting portion and a second insulation portion, and a second insulation provided on a surface of the second insulation portion, and the first insulation portion is connected to the second connecting portion through the first insulation, and is insulated.

An electric machine of the present disclosure is an electric machine including: a rotator; a stator including a first coil and a second coil which are disposed to surround the rotator; and the bus bar unit, wherein the first conductive bar is electrically connected to the first coil, and is supported by the first coil, the second conductive bar is electrically connected to the second coil, and is supported by the second coil, and each of the first insulation and the second insulation is separated from the rotator and the stator.

According to the present disclosure, a reduction in size may be realized.

### BRIEF DESCRIPTION OF THE DRAWINGS

FIG. 1 is a view illustrating an internal structure of an electric machine of an example.

FIG. 2 is a perspective view of a bus bar unit shown in FIG. 1.

FIG. 3 is a plan view of a first bus bar of the bus bar unit shown in FIG. 2.

FIG. 4 is a bottom view of the first bus bar shown in FIG. 3.

FIG. 5 is a plan view of the bus bar unit shown in FIG. 2.

FIG. 6 is a cross-sectional view taken along line VI-VI shown in FIG. 5.

FIG. 7 is a side view of a part of the bus bar unit shown in FIG. 2.

FIG. 8 is a view illustrating respective processes of a method for producing the bus bar unit shown in FIG. 2.

FIG. 9 is a cross-sectional view of a bus bar unit of a modification example.

### DETAILED DESCRIPTION

A bus bar unit production method of the present disclosure is a method for producing a bus bar unit that is used in an electric machine. The method includes: a first process of preparing a first conductive bar including a first connecting portion and a first insulation portion, and a second conductive bar including a second connecting portion and a second insulation portion; a second process of providing a first insulation on a surface of the first insulation portion to form a first bus bar, and providing a second insulation on a surface of the second insulation portion to form a second bus bar; and a third process of connecting the second connecting portion to the first insulation portion through the first insulation so that the first insulation portion and the second connecting portion are insulated, thereby forming the bus bar unit including the first bus bar and the second bus bar.

According to the production method, in the second process, the first insulation is provided in the first insulation portion of the first conductive bar, and the second insulation is provided on the surface of the second insulation portion of the second conductive bar. In addition, in the third process, the second connecting portion is connected to the first insulation portion through the first insulation so that the first insulation portion and the second connecting portion are insulated. According to this, a reduction in size of the first insulation may be realized while securing a function of insulating between the first conductive bar and the second conductive bar as a function of the first insulation. As a result, a reduction in size of the bus bar unit may be realized.

A bus bar of the present disclosure is a bus bar that is used in an electric machine. The bus bar includes: a conductive bar including a connecting portion and an insulation portion; and an insulation provided on a surface of the insulation portion. The conductive bar is connected to a conductive bar different from the conductive bar through the insulation, and is insulated.

In the bus bar, the insulation is provided in the insulation portion of the conductive bar, and the conductive bar is connected to an additional conductive bar through the insulation and is insulated. According to this, a reduction in size of the insulation may be realized while securing a function of insulating between respective conductive bars as a function of the insulation. As a result, a reduction in size of the bus bar may be realized.

The insulation may be joined to the surface of the insulation portion to be integrated with the conductive bar. According to this, the conductive bar and the insulation may be handled as one component, and a reduction in the number of components may be realized.

The insulation portion may include an exposure region exposed from the insulation. According to this, a further reduction in size of the insulation may be realized.

The conductive bar may have a plate shape with a width greater than a thickness, and the exposure region may be at least a part of one main surface of the conductive bar. According to this, since an area of the exposure region increases, and thus cooling efficiency of the conductive bar is improved.

A material of the insulation may be a resin. According to this, an inexpensive insulation may be readily obtained.

The insulation may be an insulating film. According to this, a reduction in thickness of the insulation may be realized.

The conductive bar may have an arc shape, and a length of the insulation portion in a circumferential direction of the conductive bar may be smaller than the half of a length of the conductive bar in the circumferential direction. According to this, since a region where the insulation is provided becomes smaller, a further reduction in size of the insulation may be realized.

A bus bar unit of the present disclosure is a bus bar unit that is used in an electric machine. The bus bar unit includes: a first bus bar; and a second bus bar different from the first bus bar. The first bus bar includes a first conductive bar including a first connecting portion and a first insulation portion, and a first insulation provided on a surface of the first insulation portion, the second bus bar includes a second conductive bar including a second connecting portion and a second insulation portion, and a second insulation provided on a surface of the second insulation portion, and the first insulation portion is connected to the second connecting portion through the first insulation, and is insulated.

In the bus bar unit, the first insulation is provided in the first insulation portion of the first conductive bar, and the first insulation portion is connected to the second connecting portion through the first insulation, and is insulated. According to this, a reduction in size of the first insulation may be realized while securing a function of insulating between the first insulation portion and the second connecting portion as a function of the first insulation. As a result, a reduction in size of the bus bar unit may be realized.

The second connecting portion may engage with the first insulation. According to this, assembly between the first bus bar and the second bus bar becomes ready.

The first insulation portion may include a first exposure region exposed from the first insulation, the second insulation portion may include a second exposure region exposed from the second insulation, and an area of the first exposure region and an area of the second exposure region may be the same as each other. According to this, a cooling deviation between the first conductive bar and the second conductive bar may be suppressed.

A shape of the first conductive bar and a shape of the second conductive bar may be the same as each other, and a shape of the first insulation and a shape of the second insulation may be the same as each other. According to this, the production cost may be suppressed by using common components.

The first insulation and the second insulation may be separated from each other. According to this, in the second conductive bar, a portion between the first insulation and the second insulation is exposed from the first insulation and the second insulation, and thus cooling efficiency of the second conductive bar may be improved.

The bus bar unit may further include a third bus bar different from the first bus bar and the second bus bar, the third bus bar may include a third conductive bar including a third connecting portion and a third insulation portion, and a third insulation provided on a surface of the third insulation portion, the second insulation portion may be connected to the third connecting portion through the second insulation and may be insulated, the third insulation portion may be connected to the first connecting portion through the third insulation, and may be insulated, and the first bus bar, the second bus bar, and the third bus bar which are connected to each other may have an annular shape with an axis. According to this, since the bus bar unit has an annular shape, the bus bar unit may be readily attached to an electric machine.

The first connecting portion may be located at a first position in an axial direction along the axis, the first insulation portion may be located at a second position in the axial direction, the second connecting portion may be located at the first position in the axial direction, the second insulation portion may be located at the second position in the axial direction, the third connecting portion may be located at the first position in the axial direction, the third insulation portion may be located at the second position in the axial direction, the first conductive bar may include a first step portion provided between the first connecting portion and the first insulation portion, the second conductive bar may include a second step portion provided between the second connecting portion and the second insulation portion, the third conductive bar may include a third step portion provided between the third connecting portion and the third insulation portion, and when viewed from the axial direction, the first insulation portion and the second connecting portion may overlap each other, the second insulation portion and the third connecting portion may overlap each other, and the third insulation portion and the first connecting portion may overlap each other. According to this, the thickness of the bus bar unit having the annular shape in the axial direction may be suppressed from being increased.

An electric machine of the present disclosure includes: a rotator; a stator including a first coil and a second coil which are disposed to surround the rotator; and the bus bar unit. The first conductive bar is electrically connected to the first coil, and is supported by the first coil, the second conductive bar is electrically connected to the second coil, and is supported by the second coil, and each of the first insulation and the second insulation is separated from the rotator and the stator.

According to the electric machine, as described above, a reduction in size of the bus bar unit may be realized due to a reduction in size of the first insulation and the second insulation, and thus a reduction in size of the electric machine may be realized. In addition, since the size of the first insulation and the second insulation is reduced, the bus bar unit may be supported by the first conductive bar supported by the first coil and the second conductive bar supported by the second coil. According to this, for example, as compared with a case where the insulation is supported by a stator or the like, a portion of the insulation for connection with the stator or the like may be omitted, and the structure of the first insulation and the second insulation may be simplified.

Hereinafter, examples of the present disclosure will be described in detail with reference to the accompanying drawings. Note that, in the drawings, the same reference numeral will be given to the same or equivalent portion, and redundant description will be omitted.

### [Bus Bar Unit]

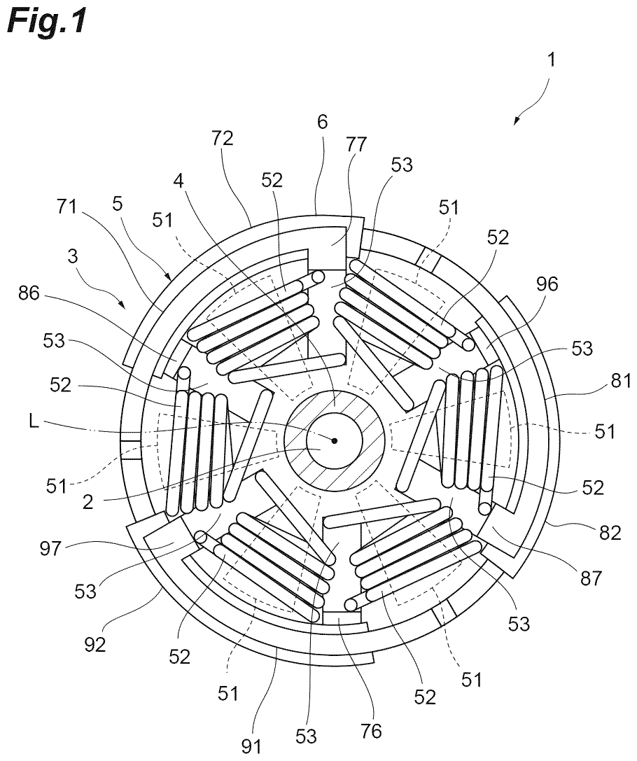

As shown in FIG. 1, an electric machine 1 includes a rotary shaft 2 and a motor 3. The rotary shaft 2 may rotate around an axis L. For example, the electric machine 1 is used in an electric supercharger (turbocharger), an electric assist supercharger (turbocharger), or the like. In these cases, a compressor impeller is attached to the rotary shaft 2.

The motor 3 includes a rotator 4, a stator 5, and a bus bar unit 6. The rotator 4 is fixed to the rotary shaft 2. The stator 5 surrounds the rotator 4 in a rotation direction of the rotary shaft 2 (hereinafter, simply referred to as “rotation direction”). The stator 5 includes a plurality of teeth 51 and a plurality of coils 52. In this example, the stator 5 includes six teeth 51 and six coils 52.

The plurality of teeth 51 are arranged to surround the rotator 4 in the rotation direction. Each of the teeth 51 is arranged at the same interval in the rotation direction. The teeth 51 is arranged, for example, for every 60° in the rotation direction. That is, the stator 5 includes a pair of the teeth 51 facing each other in three sets.

The coil 52 is provided in each of the teeth 51. That is, the plurality of coils 52 are arranged to surround the rotator 4 in the rotation direction. Each of the coils 52 is arranged at the same interval in the rotation direction. The coil 52 is arranged, for example, for every 60° in the rotation direction. That is, the stator 5 includes a pair of the coils 52 facing each other in three sets.

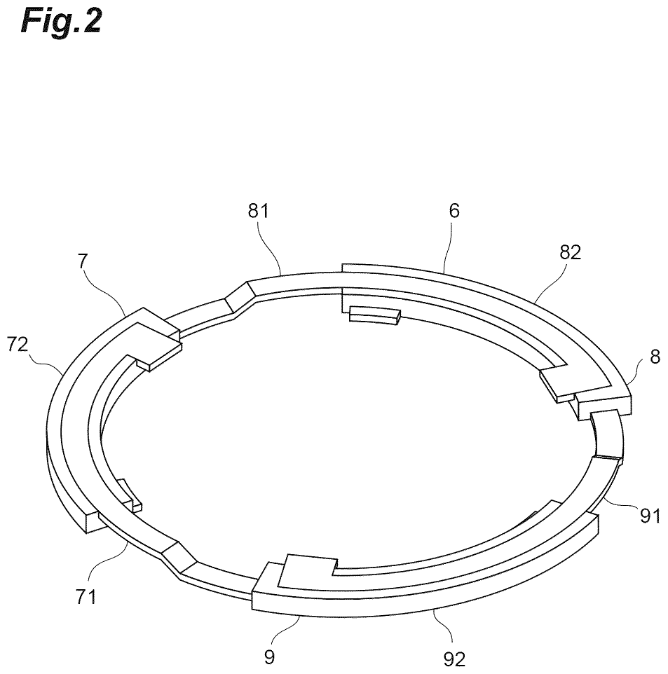

The bus bar unit 6 has, for example, an annular shape. In the bus bar unit 6, the axis L is set as an axial line. The bus bar unit 6 is arranged to surround the plurality of teeth 51 and the plurality of coils 52 in the rotation direction. The bus bar unit 6 electrically connects the facing coils 52 with respect to the three pairs of coils 52. As shown in FIG. 2, the bus bar unit 6 includes a first bus bar 7, a second bus bar 8, and a third bus bar 9. The first bus bar 7, the second bus bar 8, and the third bus bar 9 are connected each other to construct the bus bar unit 6 having the annular shape.

The first bus bar 7 includes a first conductive bar 71 and a first insulation 72. For example, the first conductive bar 71 has an arc shape in which the axis L is set as an axial line. A circumferential direction of the first conductive bar 71 matches the rotation direction. A central angle of the first conductive bar 71 is, for example, approximately 180°. The first conductive bar 71 has, for example, a plate shape. A thickness direction of the first conductive bar 71 matches a direction along the axis L (hereinafter, referred to as “axial direction”). A material of the first conductive bar 71 is, for example, copper. The first insulation 72 is provided on a part of a surface of the first conductive bar 71. A material of the first insulation 72 is, for example, a resin.

The second bus bar 8 is a bus bar different (separate) from the first bus bar 7, and a configuration of the second bus bar 8 is the same as the configuration of the first bus bar 7. Specifically, the second bus bar 8 includes a second conductive bar 81 and a second insulation 82. The second conductive bar 81 has, for example, an arc shape in which the axis L is set as an axial line. A circumferential direction of the second conductive bar 81 matches the rotation direction. A central angle of the second conductive bar 81 is, for example, approximately 180°. The second conductive bar 81 has, for example, a plate shape. A thickness direction of the second conductive bar 81 matches the axial direction. A material of the second conductive bar 81 is, for example, copper. The second insulation 82 is provided on a part of a surface of the second conductive bar 81. A material of the second insulation 82 is, for example, a resin.

The third bus bar 9 is a bus bar different (separate) from the first bus bar 7 and the second bus bar 8. A configuration of the third bus bar 9 is the same as the configuration of each of the first bus bar 7 and the second bus bar 8. Specifically, the third bus bar 9 includes a third conductive bar 91 and a third insulation 92. The third conductive bar 91 has, for example, an arc shape in which the axis L is set as an axial line. A circumferential direction of the third conductive bar 91 matches the rotation direction. A central angle of the third conductive bar 91 is, for example, approximately 180°. The third conductive bar 91 has, for example, a plate shape. A thickness direction of the third conductive bar 91 matches the axial direction. A material of the third conductive bar 91 is, for example, copper. The third insulation 92 is provided on a part of a surface of the third conductive bar 91. A material of the third insulation 92 is, for example, a resin.

When viewed from the axial direction, the first conductive bar 71 and the second conductive bar 81 partially overlap each other. When viewed from the axial direction, the second conductive bar 81 and the third conductive bar 91 partially overlap each other. When viewed from the axial direction, the third conductive bar 91 and the first conductive bar 71 partially overlap each other. The first insulation 72 connects and insulates the first conductive bar 71 and the second conductive bar 81. The second insulation 82 connects and insulates the second conductive bar 81 and the third conductive bar 91. The third insulation 92 connects and insulates the third conductive bar 91 and the first conductive bar 71. In this example, insulation represents electric insulation.

Next, the first bus bar 7 will be described in detail. In this example, as described above, since each configuration of the first bus bar 7, the second bus bar 8, and the third bus bar 9 is the same as each other, description relating to the second bus bar 8 and the third bus bar 9 may be omitted in some cases. Note that, in the drawings, only respective configurations of the first bus bar 7 may be shown in the drawings, and reference numerals of respective configurations of the second bus bar 8 which correspond to the respective configurations of the first bus bar 7, and reference numerals of respective configurations of the third bus bar 9 which correspond to the respective configurations of the first bus bar 7 may be described in parentheses after the reference numerals of the respective configurations of the first bus bar 7.

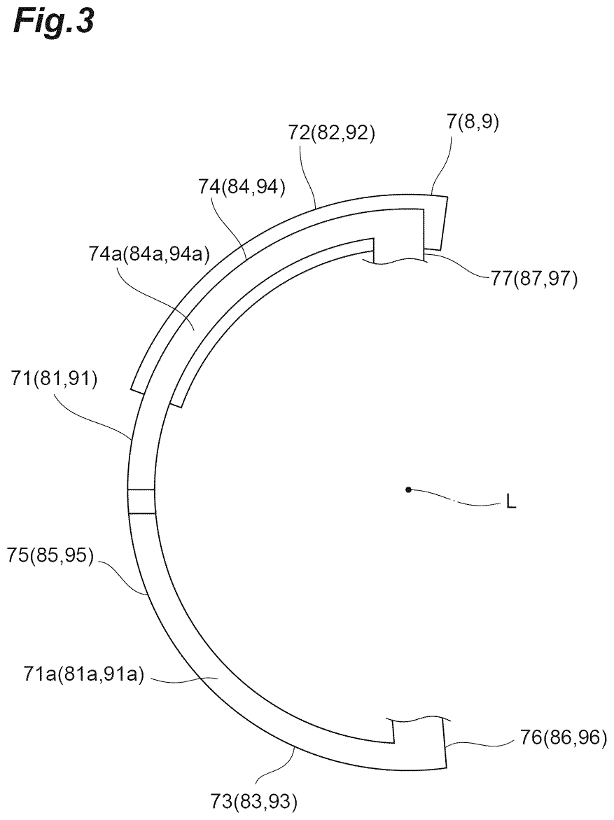

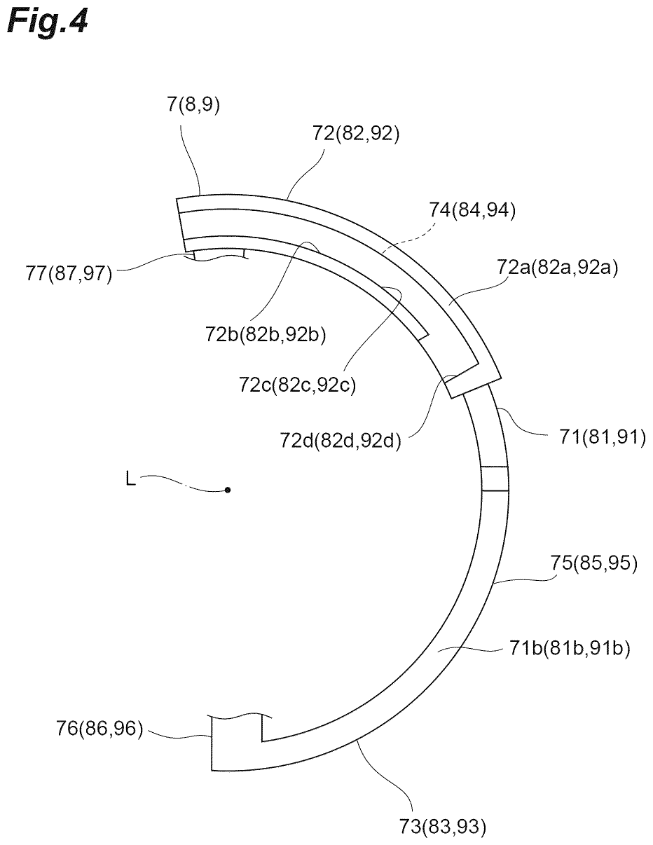

As shown in FIG. 3 and FIG. 4, the first conductive bar 71 includes a main surface 71a on one side, and the other main surface 71b on a side opposite to the main surface 71a. The first conductive bar 71 includes a first connecting portion 73, a first insulation portion 74, a first middle portion 75, and first protruding portions 76 and 77. The first connecting portion 73 is a portion on a side of one end of the first conductive bar 71 in the circumferential direction of the first conductive bar 71 (hereinafter, simply referred to as “circumferential direction”). The first connecting portion 73 has an arc shape extending along the circumferential direction. The first insulation portion 74 is a portion on a side of the other end of the first conductive bar 71 in the circumferential direction. The first insulation portion 74 has an arc shape extending along the circumferential direction. A length of the first insulation portion 74 in the circumferential direction is smaller than the half of a length of the first conductive bar 71 in the circumferential direction. The first middle portion 75 is a portion provided between the first connecting portion 73 and the first insulation portion 74 in the first conductive bar 71. The first middle portion 75 has an arc shape extending along the circumferential direction.

The first protruding portion 76 is located at one end of the first connecting portion 73 in the circumferential direction. The first protruding portion 76 protrudes from the first connecting portion 73 toward an inner side of a radial direction of the first conductive bar 71 (hereinafter, simply referred to as “radial direction”). A first protruding portion 77 is located at the other end of the first insulation portion 74 in the circumferential direction. The first protruding portion 77 protrudes from the first insulation portion 74 toward an inner side in the radial direction of the first conductive bar 71. The first protruding portion 76 and the first protruding portion 77 face each other.

Widths of the first connecting portion 73, the first insulation portion 74, and the first middle portion 75 in the radial direction of the first conductive bar 71 are the same as each other. Lengths of the first protruding portion 76 and the first protruding portion 77 in the circumferential direction are the same as each other. Widths of the first protruding portion 76 and the first protruding portion 77 in the radial direction are the same as each other. The thicknesses of the first connecting portion 73, the first insulation portion 74, the first middle portion 75, and the first protruding portions 76 and 77 are the same as each other. The width of the first conductive bar 71 in the radial direction is greater than the thickness of the first conductive bar 71. The first connecting portion 73, the first insulation portion 74, the first middle portion 75, and the first protruding portions 76 and 77 are integrally formed with the same material.

The first insulation 72 is provided on a surface of the first insulation portion 74. The first insulation 72 is joined to the first insulation portion 74 to be integrated with the first conductive bar 71. The first insulation 72 is formed integrally with the first conductive bar 71, for example, by insert molding. The first insulation 72 is directly fixed to the first conductive bar 71 without adhesive or the like. The first insulation 72 has an arc shape extending along the circumferential direction. The first insulation 72 is provided in an entire region of the first insulation portion 74 in the circumferential direction. In the circumferential direction, a portion where the first insulation 72 is provided in the first conductive bar 71 is the first insulation portion 74. In other words, in the circumferential direction, a region occupied by the first insulation portion 74 in the first conductive bar 71 is defined by the first insulation 72.

The first insulation 72 is provided in a region, which corresponds to the first insulation portion 74, in the main surface 71b of the first conductive bar 71, and a region, which corresponds to the first insulation portion 74, in respective side surfaces (an inner surface in the radial direction and an outer surface in the radial direction) of the first conductive bar 71. The first insulation 72 covers these regions of the first conductive bar 71. The first insulation portion 74 includes a first exposure region 74a exposed from the first insulation 72. The first exposure region 74a is at least a part of the main surface 71a of the first conductive bar 71. In this example, the first exposure region 74a is an entire region corresponding to the first insulation portion 74 in the main surface 71a. That is, the first insulation 72 is not provided in a region corresponding to the first insulation portion 74 in the main surface 71a.

The first insulation 72 is provided at a part of a side of a base end of the first protruding portion 77. The first insulation 72 is provided in a region corresponding to a part of the side of the base end of the first protruding portion 77 in the main surface 71b, and a region corresponding to a part of the side of the base end of the first protruding portion 77 in the respective side surfaces of the first conductive bar 71. The first insulation 72 covers these regions of the first conductive bar 71. A part of the side of the base end of the first protruding portion 77 includes an exposure region exposed from the first insulation 72. The exposure region is a region corresponding to a part of the side of the base end of the first protruding portion 77 in the main surface 71a. The first insulation 72 is not provided in the region corresponding to the part of the side of the base end of the first protruding portion 77 in the main surface 71a. The first insulation 72 is not provided at a part of a side of the tip end of the first protruding portion 77. The part of the side of the tip end of the first protruding portion 77 protrudes from the first insulation 72 toward an inner side of the first conductive bar 71.

In the first insulation 72, a concave portion 72b is formed in a surface 72a opposite to the first conductive bar 71. The concave portion 72b does not pass through the first insulation 72 in the axial direction. That is, the concave portion 72b does not reach the main surface 71b of the first conductive bar 71. A depth of the concave portion 72b is approximately the same as the thickness of the first connecting portion 73. The concave portion 72b includes a first region 72c and a second region 72d. The first region 72c has an arc shape extending along the circumferential direction.

The first region 72c ranges from a position on a side of the other end of the first insulation 72 in the circumferential direction with respect to one end of the first insulation 72 in the circumferential direction, to the other end of the first insulation 72 in the circumferential direction. The first region 72c is not opened to the one end of the first insulation 72 in the circumferential direction. The first region 72c is opened to the other end of the first insulation 72 in the circumferential direction. The first region 72c does not pass through the first insulation 72 in the radial direction. The first region 72c does not reach both ends of the first insulation 72 in the radial direction.

When viewed from the axial direction, the first region 72c overlaps the first insulation portion 74. When viewed from the axial direction, an outer edge of the first region 72c matches an outer edge of the first insulation portion 74. When viewed from the axial direction, an inner edge of the first region 72c matches an inner edge of the first insulation portion 74. A length of the first region 72c in the circumferential direction is approximately the same as a length of the first connecting portion 73 in the circumferential direction. A width of the first region 72c in the radial direction is approximately the same as a width of the first connecting portion 73 in the radial direction.

The second region 72d is located at one end of the first region 72c in the circumferential direction. The second region 72d is located on an inner side in the radial direction with respect to the first region 72c. The second region 72d communicates with the first region 72c. The second region 72d reaches an inner edge of the first insulation 72. The second region 72d is opened to the inner edge of the first insulation 72. A length of the second region 72d in the circumferential direction is approximately the same as a length of the first protruding portion 76 in the circumferential direction. A width of the second region 72d in the radial direction is smaller than a width of the first protruding portion 76 in the radial direction.

The first insulation 72 is not provided in the first connecting portion 73 and the first middle portion 75. That is, the first connecting portion 73 and the first middle portion 75 are exposed from the first insulation 72. A length of the first insulation 72 in the circumferential direction is smaller than the half of the length of the first conductive bar 71 in the circumferential direction. The volume of the first insulation 72 is smaller than the volume of the first conductive bar 71. The weight of the first insulation 72 is smaller than the weight of the first conductive bar 71.

The second conductive bar 81 is the same as the first conductive bar 71. A shape of the second conductive bar 81 is the same as the shape of the first conductive bar 71. The size of the second conductive bar 81 is the same as the size of the first conductive bar 71. A main surface 81a of the second conductive bar 81 is the same as the main surface 71a of the first conductive bar 71. A main surface 81b of the second conductive bar 81 is the same as the main surface 71b of the first conductive bar 71. A second connecting portion 83 is the same as the first connecting portion 73. A second insulation portion 84 is the same as the first insulation portion 74. A second middle portion 85 is the same as the first middle portion 75. A second protruding portion 86 is the same as the first protruding portion 76. A second protruding portion 87 is the same as the first protruding portion 77. The second insulation 82 is the same as the first insulation 72. A shape of the second insulation 82 is the same as the shape of the first insulation 72. The size of the second insulation 82 is the same as the size of the first insulation 72. A concave portion 82b of the second insulation 82 is the same as the concave portion 72b of the first insulation 72. A first region 82c of the concave portion 82b is the same as the first region 72c of the concave portion 72b. A second region 82d of the concave portion 82b is the same as the second region 72d of the concave portion 72b.

The third conductive bar 91 is the same as the first conductive bar 71. A shape of the third conductive bar 91 is the same as the shape of the first conductive bar 71. The size of the third conductive bar 91 is the same as the size of the first conductive bar 71. A main surface 91a of the third conductive bar 91 is the same as the main surface 71a of the first conductive bar 71. A main surface 91b of the third conductive bar 91 is the same as the main surface 71b of the first conductive bar 71. A third connecting portion 93 is the same as the first connecting portion 73. A third insulation portion 94 is the same as the first insulation portion 74. A third middle portion 95 is the same as the first middle portion 75. A third protruding portion 96 is the same as the first protruding portion 76. A third protruding portion 97 is the same as the first protruding portion 77. A third insulation 92 is the same as the first insulation 72. A shape of the third insulation 92 is the same as the shape of the first insulation 72. The size of the third insulation 92 is the same as the size of the first insulation 72. A concave portion 92b of the third insulation 92 is the same as the concave portion 72b of the first insulation 72. A first region 92c of the concave portion 92b is the same as the first region 72c of the concave portion 72b. A second region 92d of the concave portion 92b is the same as the second region 72d of the concave portion 72b.

As described above, the respective configurations of the first bus bar 7, the second bus bar 8, and the third bus bar 9 are the same in the shape, the size, the material, and the like. As a component of each of the first bus bar 7, the second bus bar 8, and the third bus bar 9, the same component is used.

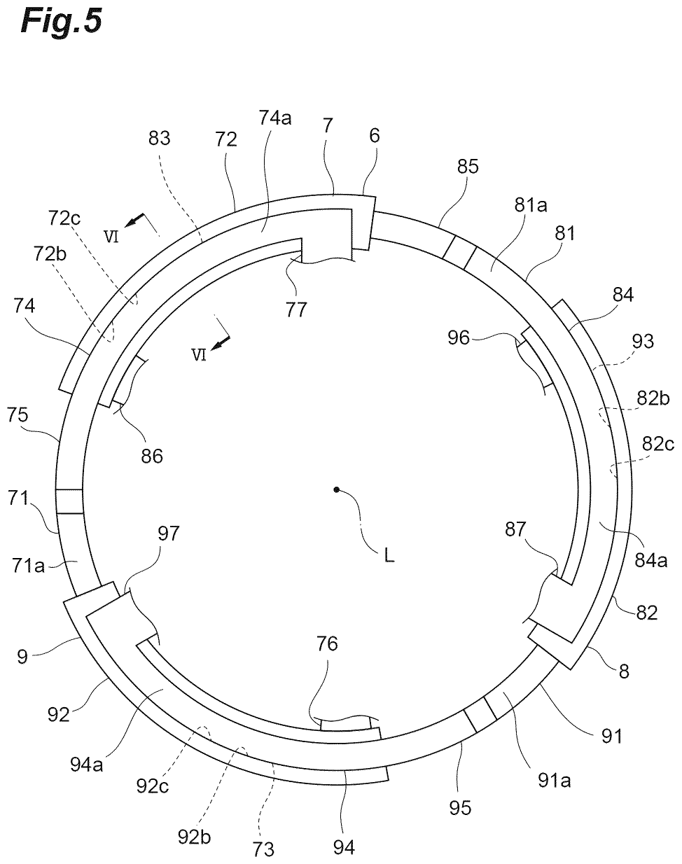

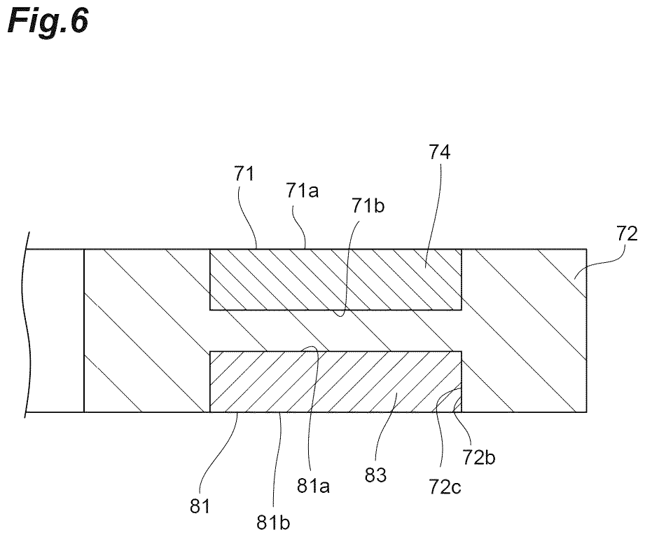

As shown in FIG. 5 and FIG. 6, the first bus bar 7, the second bus bar 8, and the third bus bar 9 are connected to each other. Specifically, the first insulation portion 74 of the first bus bar 7 is connected to the second connecting portion 83 of the second bus bar 8 through the first insulation 72. The second connecting portion 83 is disposed in the first region 72c of the concave portion 72b of the first insulation 72. The second connecting portion 83 engages with the first region 72c. The second connecting portion 83 is pressed into the first region 72c. The first insulation 72 is elastically deformed due to pressing-into of the second connecting portion 83. The second connecting portion 83 receives a load from the first insulation 72. The second connecting portion 83 is fixed to the first insulation 72 by a frictional force generated between the second connecting portion 83 and the first insulation 72. The second connecting portion 83 is in contact with a bottom surface of the first region 72c. In the main surface 81b of the second conductive bar 81, a region corresponding to the second connecting portion 83 is exposed from the first insulation 72.

A part of a side of a base end of the second protruding portion 86 in the second bus bar 8 is disposed in the second region 72d of the concave portion 72b (refer to FIG. 4). The part of the side of the base end of the second protruding portion 86 engages with the second region 72d. According to this, the second protruding portion 86 is fixed to the first insulation 72 in a similar manner as in the second connecting portion 83. A part of a side of a tip end of the second protruding portion 86 protrudes from the first insulation 72 toward an inner side of the first insulation 72 in the radial direction. The second protruding portion 86 is in contact with a bottom surface of the second region 72d. In the main surface 81b of the second conductive bar 81, a region corresponding to a part of a side of a base end of the second protruding portion 86, and the part of the side of the tip end of the second protruding portion 86 are exposed from the first insulation 72.

The first insulation portion 74 and the second connecting portion 83 are insulated by the first insulation 72. The first protruding portion 77 of the first bus bar 7 and the second connecting portion 83 are insulated by the first insulation 72. The second protruding portion 86 of the second bus bar 8 and the first insulation portion 74 are insulated by the first insulation 72.

As in the case with the first bus bar 7, the second insulation portion 84 of the second bus bar 8 is connected to the third connecting portion 93 of the third bus bar 9 through the second insulation 82. The third connecting portion 93 is disposed in the first region 82c of the concave portion 82b of the second insulation 82. The third connecting portion 93 engages with the first region 82c. The third connecting portion 93 is pressed into the first region 82c. The second insulation 82 is elastically deformed by the pressing-into of the third connecting portion 93. The third connecting portion 93 receives a load from the second insulation 82. The third connecting portion 93 is fixed to the second insulation 82 by a frictional force generated between the third connecting portion 93 and the second insulation 82. The third connecting portion 93 is in contact with a bottom surface of the first region 82c. In the main surface 91b of the third conductive bar 91, a region corresponding to the third connecting portion 93 is exposed from the second insulation 82.

A part of a side of a base end of the third protruding portion 96 of the third bus bar 9 is disposed in the second region 82d of the concave portion 82b (refer to FIG. 4). The part of the side of the base end of the third protruding portion 96 engages with the second region 82d.

According to this, the third protruding portion 96 is fixed to the second insulation 82 in a similar manner as in the third connecting portion 93. A part of a side of a tip end of the third protruding portion 96 protrudes from the second insulation 82 toward an inner side of the second insulation 82 in the radial direction. The third protruding portion 96 is in contact with a bottom surface of the second region 82d. In the main surface 91b of the third conductive bar 91, a region corresponding to the part of the side of the base end of the third protruding portion 96, and a part of a side of a tip end of the third protruding portion 96 are exposed from the second insulation 82.

The second insulation portion 84 and the third connecting portion 93 are insulated by the second insulation 82. The second protruding portion 87 of the second bus bar 8 and the third connecting portion 93 are insulated by the second insulation 82. The third protruding portion 96 of the third bus bar 9 and the second insulation portion 84 are insulated by the second insulation 82.

As is the case with the first bus bar 7, the third insulation portion 94 of the third bus bar 9 is connected to the first connecting portion 73 of the first bus bar 7 through the third insulation 92. The first connecting portion 73 is disposed in the first region 92c of the concave portion 92b of the third insulation 92. The first connecting portion 73 engages with the first region 92c. The first connecting portion 73 is pressed into the first region 92c. The third insulation 92 is elastically deformed by the pressing-into of the first connecting portion 73. The first connecting portion 73 receives a load from the third insulation 92. The first connecting portion 73 is fixed to the third insulation 92 by a frictional force generated between the first connecting portion 73 and the third insulation 92. The first connecting portion 73 is in contact with a bottom surface of the first region 92c. In the main surface 71b of the first conductive bar 71, a region corresponding to the first connecting portion 73 is exposed from the third insulation 92.

A part of a side of a base end of the first protruding portion 76 of the first bus bar 7 is disposed in the second region 92d of the concave portion 92b (refer to FIG. 4). The part of the side of the base end of the first protruding portion 76 engages with the second region 92d. According to this, the first protruding portion 76 is fixed to the third insulation 92 in a similar manner as in the first connecting portion 73. A part of a side of a tip end of the first protruding portion 76 protrudes from the third insulation 92 toward an inner side of the radial direction of the third insulation 92. The first protruding portion 76 is in contact with a bottom surface of the second region 92d. In the main surface 71b of the first conductive bar 71, a region corresponding to the part of the side of the base end of the first protruding portion 76, and the part of the side of the tip end of the first protruding portion 76 are exposed from the third insulation 92.

The third insulation portion 94 and the first connecting portion 73 are insulated by the third insulation 92. The third protruding portion 97 of the third bus bar 9 and the first connecting portion 73 are insulated by the third insulation 92. The first protruding portion 76 of the first bus bar 7 and the third insulation portion 94 are insulated by the third insulation 92.

When viewed from the axial direction, the first insulation portion 74 and the second connecting portion 83 overlap each other. A part of the first insulation 72 is interposed between the first insulation portion 74 and the second connecting portion 83. When viewed from the axial direction, the second insulation portion 84 and the third connecting portion 93 overlap each other. A part of the second insulation 82 is interposed between the second insulation portion 84 and the third connecting portion 93. When viewed from the axial direction, the third insulation portion 94 and the first connecting portion 73 overlap each other. A part of the third insulation 92 is interposed between the third insulation portion 94 and the first connecting portion 73.

The first insulation 72, the second insulation 82, and the third insulation 92 are separated from each other. A length of a portion (the first middle portion 75) between the third insulation 92 and the first insulation 72 in the first conductive bar 71 in the circumferential direction, a length of a portion (the second middle portion 85) between the first insulation 72 and the second insulation 82 in the second conductive bar 81 in the circumferential direction, and a length of a portion (the third middle portion 95) between the second insulation 82 and the third insulation 92 in the third conductive bar 91 in the circumferential direction are the same as each other.

In the bus bar unit 6, exposed areas of the first conductive bar 71, the second conductive bar 81, and the third conductive bar 91 are the same each other. Specifically, surface areas of the first middle portion 75, the second middle portion 85, and the third middle portion 95 are the same as each other. Areas of the first exposure region 74a of the first insulation portion 74, a second exposure region 84a of the second insulation portion 84, and a third exposure region 94a of the third insulation portion 94 are the same as each other. Areas of a region corresponding to the first connecting portion 73 in the main surface 71b of the first conductive bar 71, a region corresponding to the second connecting portion 83 in the main surface 81b of the second conductive bar 81, and a region corresponding to the third connecting portion 93 in the main surface 91b of the third conductive bar 91 are the same as each other.

Surface areas of a portion exposed from the first insulation 72 in the first protruding portion 77, a portion exposed from the second insulation 82 in the second protruding portion 87, and a portion exposed from the third insulation 92 in the third protruding portion 97 are the same as each other. Surface areas of a portion exposed from the third insulation 92 in the first protruding portion 76, a portion exposed from the first insulation 72 in the second protruding portion 86, and a portion exposed from the second insulation 82 in the third protruding portion 96 are the same as each other.

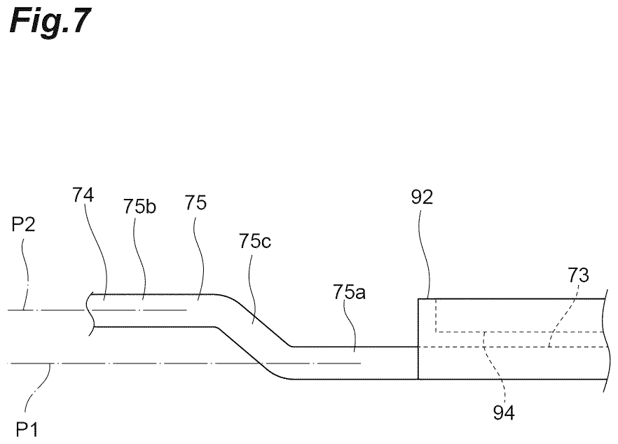

Next, the first middle portion 75 of the first bus bar 7 will be described. As shown in FIG. 7, the first middle portion 75 is located between the first connecting portion 73 and the first insulation portion 74. The first connecting portion 73 is located at a first position P1 in the axial direction. The first connecting portion 73 is located at the first position P1 and extends in a plane orthogonal to the axial direction. The first insulation portion 74 is located at a second position P2 in the axial direction. The second position P2 is a position different from the first position P1. The first insulation portion 74 is located at the second position P2 and extends in a plane orthogonal to the axial direction. When viewed from the axial direction, the first connecting portion 73 and the first insulation portion 74 are separated from each other in the circumferential direction.

The first middle portion 75 includes a first portion 75a located at the first position P1, a second portion 75b located at the second position P2, and a first step portion 75c that ranges from the first position P1 to the second position P2. The first portion 75a extends in a plane orthogonal to the axial direction. The first portion 75a is connected to the first connecting portion 73. The second portion 75b extends in a plane orthogonal to the axial direction. The second portion 75b is connected to the first insulation portion 74. The first step portion 75c is connected to the first portion 75a and the second portion 75b between the first portion 75a and the second portion 75b. The first step portion 75c diagonally intersects each of the first portion 75a and the second portion 75b.

The second middle portion 85 of the second bus bar 8 is the same as the first middle portion 75. A first portion of the second middle portion 85 is the same as the first portion 75a. A second portion of the second middle portion 85 is the same as the second portion 75b. A second step portion of the second middle portion 85 is the same as the first step portion 75c. A third middle portion 95 of the third bus bar 9 is the same as the first middle portion 75. A first portion of the third middle portion 95 is the same as the first portion 75a. A second portion of the third middle portion 95 is the same as the second portion 75b. A second step portion of the third middle portion 95 is the same as the first step portion 75c.

As described above, in the bus bar unit 6, the first connecting portion 73 of the first conductive bar 71, the second connecting portion 83 of the second conductive bar 81, and the third connecting portion 93 of the third conductive bar 91 are located at the first position P1, and the first insulation portion 74 of the first conductive bar 71, the second insulation portion 84 of the second conductive bar 81, and the third insulation portion 94 of the third conductive bar 91 are located at the second position P2. According to this, an increase in the thickness of the bus bar unit 6 in the axial direction may be suppressed while forming the bus bar unit 6 having an annular shape.

As shown in FIG. 1, the motor 3 includes a plurality of connection members 53. In this example, the motor 3 includes six pieces of the connection members 53. The plurality of connection member 53 are arranged to surround the rotator 4 in the rotation direction. Each of the connection members 53 is arranged at the same interval in the rotation direction. Each of the connection members 53 is arranged, for example, for every 60° in the rotation direction. Each of the connection member 53 is arranged between the teeth 51 adjacent to each other. Each of the connection member 53 has, for example, a plate shape. Each of the connection member 53 is arranged to extend along the radial direction. A material of the connection member 53 is, for example, copper.

Each of the connection member 53 is electrically connected to a corresponding coil 52. Each of the connection member 53 is fixed to the corresponding coil 52, for example, by welding. Each of the connection member 53 is supported by the corresponding coil 52. The first protruding portions 76 and 77 of the first conductive bar 71 are electrically connected to a pair of the coils (first coils) 52 facing each other. The first protruding portions 76 and 77 are fixed to the pair of coils (first coils) 52 facing each other, for example, by welding. The first protruding portions 76 and 77 are supported by the pair of coils 52.

The second protruding portions 86 and 87 of the second conductive bar 81 are electrically connected to a pair of the coils (second coils) 52 facing each other. The second protruding portions 86 and 87 are fixed to the pair of coils (second coils) 52 facing each other, for example, by welding. The second protruding portions 86 and 87 are supported by the pair of coils 52. The third protruding portions 96 and 97 of the third conductive bar 91 are electrically connected to a pair of the coils (third coils) 52 facing each other. The third protruding portions 96 and 97 are fixed to the pair of coils (third coils) 52 facing each other, for example, by welding. The third protruding portions 96 and 97 are supported by the pair of coils 52.

The first insulation 72, the second insulation 82, and the third insulation 92 are separated from the rotator 4 and the stator 5. The first insulation 72, the second insulation 82, and the third insulation 92 are separated from respective components of the motor 3. The first insulation 72 is in contact with only the first conductive bar 71 and the second conductive bar 81. The first insulation 72 is supported by the first conductive bar 71 and the second conductive bar 81. The second insulation 82 is in contact with only the second conductive bar 81 and the third conductive bar 91. The second insulation 82 is supported by the second conductive bar 81 and the third conductive bar 91. The third insulation 92 is in contact with only the third conductive bar 91 and the first conductive bar 71. The third insulation 92 is supported by the third conductive bar 91 and the first conductive bar 71.

As described above, in the first bus bar 7, the first insulation 72 is provided in the first insulation portion 74 in the first conductive bar 71. The first conductive bar 71 is connected to the second conductive bar 81 through the first insulation 72, and is insulated. According to this, a reduction in size of the first insulation 72 may be realized while securing a function of insulating between the first conductive bar 71 and the second conductive bar 81 as a function of the first insulation 72. As a result, a reduction in size of the first bus bar 7 may be realized.

The first insulation 72 is joined to a surface of the first insulation portion 74 to be integrated with the first conductive bar 71. According to this, the first conductive bar 71 and the first insulation 72 may be handled as one component, and a reduction in the number of components may be realized. In addition, for example, a connection member or the like for providing the first insulation on the surface of the first insulation portion 74 is not necessary, and thus a reduction in the number of components and simplification of the structure of the first bus bar 7 may be realized.

The first insulation portion 74 includes the first exposure region 74a exposed from the first insulation 72. According to this, a further reduction in size of the first insulation 72 may be realized. In addition, a reduction in the material of the first insulation 72 may be realized.

The first conductive bar 71 has a plate shape having a width greater than a thickness. The first exposure region 74a is at least a part of one main surface 71a of the first conductive bar 71. According to this, an area of the first exposure region 74a increases, and thus cooling efficiency of the first conductive bar 71 is improved.

A material of the first insulation 72 is a resin. According to this, the first insulation 72 that is inexpensive may be readily obtained.

The first conductive bar 71 has an arc shape. The length of the first insulation portion 74 in the circumferential direction of the first conductive bar 71 is smaller than the half of the length of the first conductive bar 71 in the circumferential direction. According to this, a region where the first insulation 72 is provided decreases, and thus a further reduction in size of the first insulation 72 may be realized.

In the bus bar unit 6, the first insulation 72 is provided in the first insulation portion 74 of the first conductive bar 71. The first insulation portion 74 is connected to the second connecting portion 83 through the first insulation 72 and is insulated. According to this, a reduction in size of the first insulation 72 may be realized while securing the function of insulating between the first insulation portion 74 and the second connecting portion 83 as a function of the first insulation 72. As a result, a reduction in size of the bus bar unit 6 may be realized.

The second connecting portion 83 engages with the first insulation 72. According to this, assembly of the first bus bar 7 and the second bus bar 8 becomes ready.

The first insulation portion 74 includes the first exposure region 74a exposed from the first insulation 72. The second insulation portion 84 includes the second exposure region 84a exposed from the second insulation 82. An area of the first exposure region 74a and an area of the second exposure region 84a are the same as each other. According to this, a deviation in cooling between the first conductive bar 71 and the second conductive bar 81 may be suppressed.

A shape of the first conductive bar 71 and a shape of the second conductive bar 81 are the same as each other. A shape of the first insulation 72 and a shape of the second insulation 82 are the same as each other. According to this, the production cost may be suppressed by using a common component.

The first insulation 72 and the second insulation 82 are separated from each other. According to this, since a portion of the second conductive bar 81 between the first insulation 72 and the second insulation 82 is exposed from the first insulation 72 and the second insulation 82, cooling efficiency of the second conductive bar 81 may be improved. In addition, for example, as compared with a case where the first insulation and the second insulation are connected to each other, a reduction in size of the insulation may be realized, and a reduction in material of the insulation may be realized.

The bus bar unit 6 includes the third bus bar 9 different (separate) from the first bus bar 7 and the second bus bar 8. The third bus bar 9 includes the third conductive bar 91 and the third insulation 92. The third conductive bar 91 includes the third connecting portion 93 and the third insulation portion 94. The third insulation 92 is provided on a surface of the third insulation portion 94. The second insulation portion 84 is connected to the third connecting portion 93 through the second insulation 82, and is insulated, and the third insulation portion 94 is connected to the first connecting portion 73 through the third insulation 92 and is insulated. The first bus bar 7, the second bus bar 8, and the third bus bar 9 which are connected to each other as described above have an annular shape. According to this, since the bus bar unit 6 has the annular shape, the bus bar unit 6 may be readily attached to the electric machine 1.

The first connecting portion 73 is located at the first position P1 in the axial direction. The first insulation portion 74 is located at the second position P2 in the axial direction. The second connecting portion 83 is located at the first position P1 in the axial direction. The second insulation portion 84 is located at the second position P2 in the axial direction. The third connecting portion 93 is located at the first position P1 in the axial direction. The third insulation portion 94 is located at the second position P2 in the axial direction. The first conductive bar 71 includes the first step portion 75c provided between the first connecting portion 73 and the first insulation portion 74. The second conductive bar 81 includes a second step portion 85c provided between the second connecting portion 83 and the second insulation portion 84. The third conductive bar 91 includes a third step portion 95c provided between the third connecting portion 93 and the third insulation portion 94. When viewed from the axial direction, the first insulation portion 74 and the second connecting portion 83 overlap each other. When viewed from the axial direction, the second insulation portion 84 and the third connecting portion 93 overlap each other. When viewed from the axial direction, the third insulation portion 94 and the first connecting portion 73 overlap each other. According to this, an increase in the thickness of the bus bar unit 6 having the annular shape in the axial direction may be suppressed.

According to the electric machine 1, as described above, a reduction in size of the bus bar unit 6 may be realized due to a reduction in size of the first insulation 72 and the second insulation 82, and thus a reduction in size of the electric machine 1 may be realized. In addition, since the size of the first insulation 72 and the second insulation 82 is reduced, the bus bar unit 6 may be supported by the first conductive bar 71 supported by the coil 52 and the second conductive bar 81 supported by the coil 52. According to this, for example, as compared with a case where the insulation is supported by the stator 5 or the like, a portion of the insulation for connection with the stator 5 or the like may be omitted, and the structure of the first insulation 72 and the second insulation 82 may be simplified. In addition, a reduction in the material of the first insulation 72 and the second insulation 82 may be realized.

### [Bus Bar Unit Production Method]

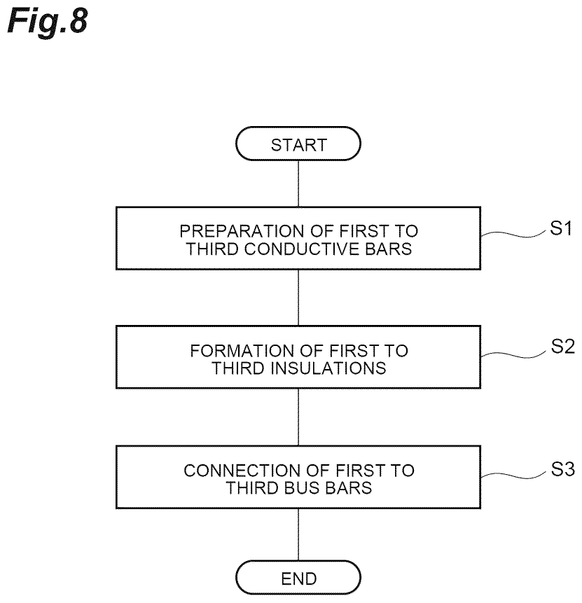

Next, a method for producing the bus bar unit 6 will be described. As shown in FIG. 8, first, the first conductive bar 71, the second conductive bar 81, and the third conductive bar 91 are prepared (step S1, first process). Next, the first insulation 72, the second insulation 82, and the third insulation 92 are provided (step S2, second process). Specifically, the first insulation 72 is formed on a surface of the first insulation portion 74 of the first conductive bar 71. The first insulation 72 is formed integrally with the first conductive bar 71, for example, by insert molding. According to this, the first bus bar 7 is formed. The second insulation 82 is formed on a surface of the second insulation portion 84 of the second conductive bar 81. The second insulation 82 is formed integrally with the second conductive bar 81, for example, by insert molding. According to this, the second bus bar 8 is formed. The third insulation 92 is formed on a surface of the third insulation portion 94 of the third conductive bar 91. The third insulation 92 is formed integrally with the third conductive bar 91, for example, by insert molding. According to this, the third bus bar 9 is formed.

Next, the first bus bar 7, the second bus bar 8, and the third bus bar 9 are connected to each other (step S3, third process). Specifically, the second connecting portion 83 is connected to the first insulation portion 74 through the first insulation 72. The second connecting portion 83 engages with the first region 72c of the concave portion 72b of the first insulation 72. The second protruding portion 86 of the second conductive bar 81 engages with the second region 72d of the concave portion 72b. The first insulation portion 74 and the second connecting portion 83 are insulated by the first insulation 72. In addition, the third connecting portion 93 is connected to the second insulation portion 84 through the second insulation 82. The third connecting portion 93 engages with the first region 82c of the concave portion 82b of the second insulation 82. The third protruding portion 96 of the third conductive bar 91 engages with the second region 82d of the concave portion 82b. The second insulation portion 84 and the third connecting portion 93 are insulated by the second insulation 82. In addition, the first connecting portion 73 is connected to the third insulation portion 94 through the third insulation 92. The first connecting portion 73 engages with the first region 92c of the concave portion 92b of the third insulation 92. The first protruding portion 76 of the first conductive bar 71 engages with the second region 92d of the concave portion 92b. The third insulation portion 94 and the first connecting portion 73 are insulated by the third insulation 92. From the above-described processes, the bus bar unit 6 having an annular shape is formed.

As described above, in step S2 in the method for producing the bus bar unit 6, the first insulation 72 is formed in the first insulation portion 74 of the first conductive bar 71, and the second insulation 82 is formed on the surface of the second insulation portion 84 of the second conductive bar 81. In addition, in step S3, the second connecting portion 83 is connected to the first insulation portion 74 through the first insulation 72 so that the first insulation portion 74 and the second connecting portion 83 are insulated. According to this, a reduction in size of the first insulation 72 may be realized while securing the function of insulating between the first conductive bar 71 and the second conductive bar 81 as a function of the first insulation 72. Accordingly, a reduction in size of the bus bar unit 6 may be realized.

Hereinbefore, an effect focused to the first bus bar 7 and the second bus bar 8 has been described, but the effect is also true of any of the first bus bar 7, the second bus bar 8, and the third bus bar 9.

### Modification Example

Hereinbefore, an example of the present disclosure has been described, but the present disclosure is not limited to the example described above.

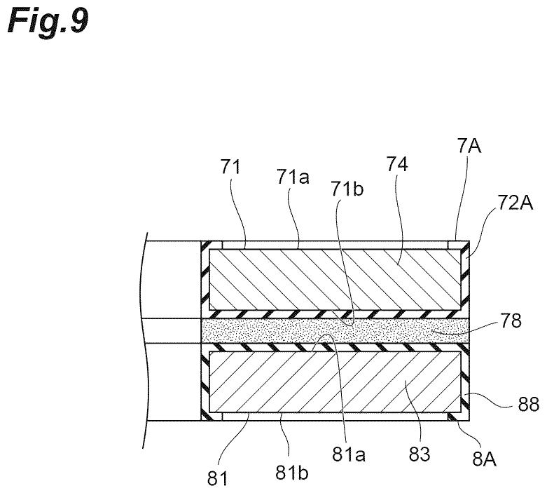

As shown in FIG. 9, a first bus bar 7A may include a first insulation 72A instead of the first insulation 72. A second bus bar 8A may further include an insulation film 88. The first insulation 72A is an insulation film formed on the surface of the first insulation portion 74. The first insulation 72A may be formed at a part of a region corresponding to the first insulation portion 74 in the main surface 71a of the first conductive bar 71.

The insulation film 88 is formed in a region corresponding to the second connecting portion 83 in the main surface 81a of the second conductive bar 81, respective side surfaces of the second connecting portion 83, and a part of a region corresponding to the second connecting portion 83 in the main surface 81b of the second conductive bar 81. Each of the first insulation 72A and the insulation film 88 is formed, for example, by a vapor deposition method using a mask or the like.

The first bus bar 7 and the second bus bar 8 are fixed to a connecting portion 78 provided between the first insulation 72A and the insulation film 88. Examples of the connecting portion 78 include adhesive and the like. In this case, a reduction in the thickness of the first insulation 72A may be realized. In addition, a reduction in material of the first insulation 72 may be realized.

As in the case with the first bus bar 7A, the second bus bar 8 may include a second insulation similar to the first insulation 72A instead of the second insulation 82. The third bus bar 9 may further include an insulation film similar to the insulation film 88 as in the case with the second bus bar 8A. The second bus bar 8 and the third bus bar may be fixed by a connecting portion similar to the connecting portion 78. As in the case with the first bus bar 7A, the third bus bar 9 may include a third insulation similar to the first insulation 72A instead of the third insulation 92. As in the case with the second bus bar 8A, the first bus bar 7 may further include an insulation film similar to the insulation film 88. The third bus bar 9 and the first bus bar 7A may be fixed to a connecting portion similar to the connecting portion 78.

In the example, an example in which the first insulation 72 is formed integrally with the first conductive bar 71 by insert molding has been described, but the first insulation 72 may engage with, for example, the first conductive bar 71. As in the case with the first insulation 72, the second insulation 82 may engage with the second conductive bar 81. As in the case with the first insulation 72, the third insulation 92 may engage with the third conductive bar 91.

In the example, an example in which the bus bar unit 6 includes three pieces of the bus bars 7, 8, and 9 has been illustrated, but the bus bar unit 6 may include four or more bus bars. The bus bar unit 6 may include two bus bars. In addition, an example in which when viewed from the axial direction, the first conductive bar 71, the second conductive bar 81, and the third conductive bar 91 partially overlap each other has been described, but when viewed from the axial direction, the first conductive bar 71, the second conductive bar 81, and the third conductive bar 91 may not partially overlap each other.

In the example, an example in which the electric machine 1 includes the motor 3 has been described, but the electric machine 1 may include a generator instead of the motor 3. As in the case of the motor 3, the generator includes the rotator 4, the stator 5, and the bus bar unit 6.

### [Supplementary Notes]

The present disclosure includes the following configurations.

The bus bar unit production method of the present disclosure is [1] “A method for producing a bus bar unit that is used in an electric machine, the method including: a first process of preparing a first conductive bar including a first connecting portion and a first insulation portion, and a second conductive bar including a second connecting portion and a second insulation portion; a second process of providing a first insulation on a surface of the first insulation portion to form a first bus bar, and providing a second insulation on a surface of the second insulation portion to form a second bus bar; and a third process of connecting the second connecting portion to the first insulation portion through the first insulation so that the first insulation portion and the second connecting portion are insulated, thereby forming the bus bar unit including the first bus bar and the second bus bar.”

The bus bar of the present disclosure is [2] “A bus bar that is used in an electric machine, the bus bar including: a conductive bar including a connecting portion and an insulation portion; and an insulation provided on a surface of the insulation portion, wherein the conductive bar is connected to a conductive bar different from the conductive bar through the insulation, and is insulated.”

The bus bar of the present disclosure may be [3] “The bus bar according to [2], wherein the insulation is joined to the surface of the insulation portion to be integrated with the conductive bar.”

The bus bar of the present disclosure may be [4] “The bus bar according to [2] or [3], wherein the insulation portion includes an exposure region exposed from the insulation.”

The bus bar of the present disclosure may be [5] “The bus bar according to [4], wherein the conductive bar has a plate shape with a width greater than a thickness, and the exposure region is at least a part of one main surface of the conductive bar.”

The bus bar of the present disclosure may be [6] “The bus bar according to any one of [2] to [5], wherein a material of the insulation is a resin.”

The bus bar of the present disclosure may be [7] “The bus bar according to any one of [2] to [6], wherein the insulation is an insulating film.”

The bus bar of the present disclosure may be [8] “The bus bar according to any one of [2] to [7], wherein the conductive bar has an arc shape, and a length of the insulation portion in a circumferential direction of the conductive bar is smaller than the half of a length of the conductive bar in the circumferential direction.”

The bus bar unit of the present disclosure is [9] “A bus bar unit that is used in an electric machine, the bus bar including: a first bus bar; and a second bus bar different from the first bus bar, wherein the first bus bar includes a first conductive bar including a first connecting portion and a first insulation portion, and a first insulation provided on a surface of the first insulation portion, the second bus bar includes a second conductive bar including a second connecting portion and a second insulation portion, and a second insulation provided on a surface of the second insulation portion, and the first insulation portion is connected to the second connecting portion through the first insulation and is insulated.”

The bus bar unit of the present disclosure may be [10] “The bus bar unit according to [9], wherein the second connecting portion engages with the first insulation.”

The bus bar unit of the present disclosure may be [11] “The bus bar unit according to [9] or [10], wherein the first insulation portion includes a first exposure region exposed from the first insulation, the second insulation portion includes a second exposure region exposed from the second insulation, and an area of the first exposure region and an area of the second exposure region are the same as each other.”

The bus bar unit of the present disclosure may be [12] “The bus bar unit according to any one of [9] to [11], wherein a shape of the first conductive bar and a shape of the second conductive bar are the same as each other, and a shape of the first insulation and a shape of the second insulation are the same as each other.”

The bus bar unit of the present disclosure may be [13] “The bus bar unit according to any one of [9] to [12], wherein the first insulation and the second insulation are separated from each other.”

The bus bar unit of the present disclosure may be [14] “The bus bar unit according to any one of [9] to [13], further including: a third bus bar different from the first bus bar and the second bus bar, wherein the third bus bar includes a third conductive bar including a third connecting portion and a third insulation portion, and a third insulation provided on a surface of the third insulation portion, the second insulation portion is connected to the third connecting portion through the second insulation and is insulated, the third insulation portion is connected to the first connecting portion through the third insulation, and is insulated, and the first bus bar, the second bus bar, and the third bus bar which are connected to each other have an annular shape with an axis.”

The bus bar unit of the present disclosure may be [15] “The bus bar unit according to [14], wherein the first connecting portion is located at a first position in an axial direction along the axis, the first insulation portion is located at a second position in the axial direction, the second connecting portion is located at the first position in the axial direction, the second insulation portion is located at the second position in the axial direction, the third connecting portion is located at the first position in the axial direction, the third insulation portion is located at the second position in the axial direction, the first conductive bar includes a first step portion provided between the first connecting portion and the first insulation portion, the second conductive bar includes a second step portion provided between the second connecting portion and the second insulation portion, the third conductive bar includes a third step portion provided between the third connecting portion and the third insulation portion, and when viewed from the axial direction, the first insulation portion and the second connecting portion overlap each other, the second insulation portion and the third connecting portion overlap each other, and the third insulation portion and the first connecting portion overlap each other.”

The electric machine of the present disclosure is [16] “An electric machine, including: a rotator; a stator including a first coil and a second coil which are disposed to surround the rotator; and the bus bar unit according to any one of [9] to [15], wherein the first conductive bar is electrically connected to the first coil, and is supported by the first coil, the second conductive bar is electrically connected to the second coil, and is supported by the second coil, and each of the first insulation and the second insulation is separated from the rotator and the stator.”

1. A method for producing a bus bar unit that is used in an electric machine, the method comprising:
a first process of preparing a first conductive bar comprising a first connecting portion and a first insulation portion, and a second conductive bar comprising a second connecting portion and a second insulation portion;
a second process of providing a first insulation on a surface of the first insulation portion to form a first bus bar, and providing a second insulation on a surface of the second insulation portion to form a second bus bar; and
a third process of connecting the second connecting portion to the first insulation portion through the first insulation so that the first insulation portion and the second connecting portion are insulated, and the bus bar unit comprising the first bus bar and the second bus bar is formed.

2. A bus bar that is used in an electric machine, the bus bar comprising:
a conductive bar comprising a connecting portion and an insulation portion; and
an insulation provided on a surface of the insulation portion,
wherein the conductive bar is connected to other conductive bar separated from the conductive bar through the insulation, and the conductive bar is insulated from the other conductive bar.

3. The bus bar according to claim 2,
wherein the insulation is joined to the surface of the insulation portion to be integrated with the conductive bar.

4. The bus bar according to claim 2,
wherein the insulation portion includes an exposure region exposed from the insulation.

5. The bus bar according to claim 4,
wherein the conductive bar has a plate shape with a width greater than a thickness, and
the exposure region is at least a part of one main surface of the conductive bar.

6. The bus bar according to claim 2,
wherein a material of the insulation is a resin.

7. The bus bar according to claim 2,
wherein the insulation is an insulating film.

8. The bus bar according to claim 2,
wherein the conductive bar has an arc shape, and
a length of the insulation portion in a circumferential direction of the conductive bar is smaller than a half of a length of the conductive bar in the circumferential direction.

9. The bus bar according to claim 2,
wherein the conductive bar comprises a protruding portion located at one end of the connecting portion in the circumferential direction, and
wherein the protruding portion protrudes from the connecting portion toward an inner side of a radial direction of the conductive bar.

10. The bus bar according to claim 2,
wherein the insulation comprises a concave portion on one main surface of the conductive bar.

11. The bus bar according to claim 10,
wherein a depth of the concave portion is substantially identical to a thickness of the connecting portion.

12. The bus bar according to claim 10,
wherein the concave portion includes a first region and a second region,
wherein the first region has an arc shape extending along the circumferential direction, and
wherein the second region communicates with the first region and reaches an inner edge of the insulation.

13. A bus bar unit that is used in an electric machine, the bus bar unit comprising:
a first bus bar; and
a second bus bar separate from the first bus bar,
wherein the first bus bar comprises:
a first conductive bar comprising a first connecting portion and a first insulation portion; and
a first insulation provided on a surface of the first insulation portion,
wherein the second bus bar comprises:
a second conductive bar comprising a second connecting portion and a second insulation portion; and
a second insulation provided on a surface of the second insulation portion, and
wherein the first insulation portion is connected to the second connecting portion through the first insulation, and the first insulation portion is insulated from the second connecting portion.

14. The bus bar unit according to claim 13,
wherein the second connecting portion engages with the first insulation.

15. The bus bar unit according to claim 13,
wherein the first insulation portion includes a first exposure region exposed from the first insulation,
wherein the second insulation portion includes a second exposure region exposed from the second insulation, and
wherein an area of the first exposure region and an area of the second exposure region are identical.

16. The bus bar unit according to claim 13,
wherein a shape of the first conductive bar and a shape of the second conductive bar are identical, and
wherein a shape of the first insulation and a shape of the second insulation are identical.

17. The bus bar unit according to claim 13,
wherein the first insulation and the second insulation are separated from each other.

18. The bus bar unit according to claim 13, further comprising:
a third bus bar separate from the first bus bar and the second bus bar,
wherein the third bus bar comprises:
a third conductive bar comprising a third connecting portion and a third insulation portion; and
a third insulation provided on a surface of the third insulation portion,
wherein the second insulation portion is connected to the third connecting portion through the second insulation and the second insulation portion is insulated from the third connecting portion,
wherein the third insulation portion is connected to the first connecting portion through the third insulation, and the third insulation portion is insulated from the first connecting portion, and
wherein the first bus bar, the second bus bar, and the third bus bar which are connected to each other have an annular shape with an axis.

19. The bus bar unit according to claim 18,
wherein the first connecting portion is located at a first position in an axial direction along the axis,
wherein the first insulation portion is located at a second position in the axial direction,
wherein the second connecting portion is located at the first position in the axial direction,
wherein the second insulation portion is located at the second position in the axial direction,
wherein the third connecting portion is located at the first position in the axial direction,
wherein the third insulation portion is located at the second position in the axial direction,
wherein the first conductive bar comprises a first step portion provided between the first connecting portion and the first insulation portion,
wherein the second conductive bar comprises a second step portion provided between the second connecting portion and the second insulation portion,
wherein the third conductive bar comprises a third step portion provided between the third connecting portion and the third insulation portion, and
wherein when viewed from the axial direction, the first insulation portion and the second connecting portion overlap each other, the second insulation portion and the third connecting portion overlap each other, and the third insulation portion and the first connecting portion overlap each other.

20. An electric machine, comprising:
a rotator;
a stator comprising a first coil and a second coil which are disposed to surround the rotator; and
the bus bar unit according to claim 13,
wherein the first conductive bar is electrically connected to the first coil, and is supported by the first coil,
wherein the second conductive bar is electrically connected to the second coil, and is supported by the second coil, and
wherein each of the first insulation and the second insulation are separated from the rotator and the stator.
